(19) United States
(12) Patent Application Publication
(10) Pub. No.: US 2013/0273199 A1
(43) Pub. Date: Oct. 17, 2013

(54) BEVERAGE AND METHOD FOR PRODUCING A SPARKLING BEVERAGE WHICH IS A NUTRITIOUS ALTERNATIVE TO MILK WITH ALL THE NUTRITION OF MILK PLUS ANTRHOCYANINS

(71) Applicants: George H. Clark, Woburn, MA (US); Mary Ann Clark, Woburn, MA (US)

(72) Inventors: George H. Clark, Woburn, MA (US); Mary Ann Clark, Woburn, MA (US)

(21) Appl. No.: 13/546,158

(22) Filed: Jul. 11, 2012

Related U.S. Application Data
(60) Provisional application No. 61/686,754, filed on Apr. 11, 2012.

(51) Int. Cl. A23C 21/06; A23C 9/12; A23C 9/158; A23C 3/00; B82Y 99/00

(52) U.S. Cl. 426/34; 426/569; 426/72; 426/73; 426/532; 977/902

(57) ABSTRACT

Dairy or non-diary based fortified carbonated beverage solutions that supply essential nutrients in the human diet. The solution contains per 354 ml, calcium, magnesium and potassium ions in the form of salts, Anthrocyanins, Amelanchia alnifolia Liquid Extract and optionally vitamins A, D, C, lutein, zeaxanthin and folic acid in specified amounts to provide dietary supplementation. Sweeteners, stabilizers, flavors and carbonation can also be added to enhance flavor, taste, mouth-feel, ingredient solubilization and product appearance. A method of making the beverages is also described. A method of using carbonation to reduce bacterial counts and reduce degradation of essential nutrients in milk-based beverages with or without pasteurization is also disclosed. Finally, a method of stabilization the mixture and achieving a higher level of purification by quantitatively separating the mixture into solid and liquid phase, treating each phase separately and then quantitatively recombining the phases before the addition of other ingredients.

### CROSS-REFERENCE TO RELATED APPLICATION

A claim of priority is made to U.S. Provisional Application Ser. No. 61/686,754, filed Apr. 9, 2012, the contents of which are incorporated in their entirety by reference.

### FIELD OF THE DISCLOSURE

This disclosure relates to a fortified Sparkling Milk-Based or Non-Dairy Based beverage for the supplementation of essential nutrients in the human diet and nutrition rich Anthrocyanins. This disclosure further relates to a method for producing sparkling milk-based or non-dairy based beverages that suppresses the growth of bacterial cultures without exposure of the products to the extreme temperatures of Ultra High Temperature Pasteurization which may inactivate heat labile nutrients, and thereby extends product shelf life and increases the palatability of milk for extended dating to populations who do not like or drink milk. The beverages are designed for consumption by individuals of all ages to provide supplemental amounts of essential vitamins, amino acids, minerals, anthrocyanins and trace nutrients in the everyday diet. The resulting product will also appeal to and be safe for those individuals who cannot drink milk due to their inability to digest milk sugar (Lactose).

### BACKGROUND OF THE DISCLOSURE

It is now well known that good nutrition is essential to the process of bone physiology. Poor dietary habits will prevent normal bone development in childhood and early adulthood and can contribute to the softening of bones and teeth as well as the acceleration of bone loss with advancing age. Milk has long been recognized as an excellent nutritional source of essential minerals such as calcium and potassium, high quality protein and vitamins such as D, A, B₂, B₁, B₆ and B₁₂.

Proper levels of these elements are essential in the diets of children and adolescents for the development and maintenance of healthy teeth and bones and to enhance growth; in adults to improve the tone and elasticity of muscles and ligaments. Such elements also assist in and promote healthy pregnancies, enhance appetite, and in the elderly, help to prevent osteoporosis, colon cancer and heart disease.

A major nutritional problem exists in North America and throughout the world in that the annual consumption of milk per capita is fourth to beer, soft drinks and bottled water. Consumers reject milk for taste, fat content, social acceptability in certain peer groups and in susceptible individuals, lactose intolerance. Recommended daily intake levels of vitamins, e.g., A, D, and the B group, as well as minerals, e.g., calcium, magnesium and potassium, cannot be supplemented by other commercial, non-dairy beverages due to unavailability. We know of no prior art that discloses any flavored, fortified, sparkling, milk-based or non-dairy beverages that provide enhanced supplementation of the levels of essential vitamins, minerals, anthrocyanins and amino acids equal to those available in this sparkling dairy alternative to milk.

When compared to skim milk, the following results are obtained.

| Per 354 ml. | SKIM MILK | DISCLOSURE |
|---|---|---|
| Calories (kilocalories) | 90 | 90 |
| Carbohydrates (g) | 16 | 13 |
| Fat (g) | 0 | 0 |
| Protein (g) | 8 | 9 |
| Cholesterol (mg) | 1 | 1 |
| Vitamin A (IU) | 1000 | 500 |
| Vitamin D (IU) | 100 | 100 |
| Vitamin C (mg) | 0.09 | 3 |
| B1 (Thiamine) (mg) | 0.17 | 0.17 |
| B2 (Riboflavin) (mg) | 0.17 | 0.17 |
| B6 (Pyrodoxine) (mg) | 0.87 | 0.87 |
| B12 (Cobolamin) (mg) | 1.34 | 1.34 |
| Folic Acid (IU) | 0 | 0.05 |
| Sodium (mg) | 122 | 115 |
| Calcium (mg) | 301 | 301 |
| Potassium (mg) | 382 | 382 |
| Phosphorus (mg) | 247 | 247 |
| Magnesium (mg) | 27 | 27 |
| Iron (mg) | 0.07 | 0.07 |
| Copper (mg) | 0.025 | 0.025 |
| Carbonation (vols) | 0 | 2.0 |

The chart clearly illustrates how our novel beverage provides, at a minimum, the same nutritional benefit as milk with respect to essential vitamins, minerals and other beneficial substances naturally present in, or added as fortifications to milk. Unless expressly stated otherwise, as used herein, all liquid components are measured in liters or fractions thereof and all solid components are measured in grams or fractions thereof.

U.S. Pat. No. 4,738,856 to Clark et al. discloses calcium, magnesium and potassium aspartate compositions as anti-hypertensive nutrition agents. Clark et al., provides that non-dairy nutritional beverages facilitate and control the transport of calcium ions into the human body while lowering blood pressure and lowering the probability or tendency of incurring colon cancer. Clark et al further discloses that beverages may provide nutritional supplementation of magnesium and/or potassium to the human diet, help reduce premenstrual tension in women, and increase cardiac tolerance in conditions of anoxia.

Clark et al. does not disclose a milk-based nutritional beverage which will provide not only large amounts of calcium, magnesium and/or potassium to the human diet, but also supplementation of essential vitamin A, vitamin D, B complex vitamins, vitamin C, vitamin K, phosphorus, iron and strontium and the antioxidant benefits of anthrocyanins. Clark et al., fails to disclose carbonation of a beverage to enhance the acceptance of the taste of B complex vitamins, minerals and iron in beverage preparations, enhance the mouth-feel of milk products to increase consumer appeal enjoyed by carbonated beverages and extend the shelf life of milk without the use of ultra-high heat pasteurization by suppressing the growth of bacteria. Clark et al, also does not disclose the use of a Liquid Extract of Amelanchia alnifolia to rehydrate Dry Skim Milk powder to provide bacteriostatic qualities to the mixture as well as cognitive performance rehabilitation to the consumer after strenuous exercise.

U.S. Pat. No. 5,624,700 to Lyon et al. discloses a process to add carbon dioxide under low shear conditions to an already formed food to produce a semi-solid or solid carbonated food. Lyon et al. does not disclose the carbonation of a dry powder preparation of vitamins and minerals or of milk to produce an enhanced liquid dairy product for the supplementation of high levels of essential vitamins and minerals in human nutrition.

What is needed and what we have invented is an all natural, flavored, fortified, carbonated milk-based beverage that provides high dietary levels of essential vitamins, minerals, anthrocyanins and amino acids that facilitates their absorption, which aids in the building of healthy bones and teeth and reduces the probability of developing osteoporosis is approved as a nutritious alternative to carbonated soft drinks and aids in the battle against childhood obesity. The inventive beverage also aids in the prevention of rickets in young people and the development of premenstrual tension (PMS) in women. Folic acid of the B-complex vitamins is supplemented by this disclosure to counter its deficiency in the typical human diet, which may cause megaloblastosis, weight loss, anemia, cardiac enlargement, congestive heart failure, and in pregnant women, development of a fetus with spina bifida. The beverage supplies a rapidly and highly absorbable source of calcium, magnesium and potassium to the human body without gastric upset and stomach bloating, and thus provides an ideal composition for consumption by humans who are “At Risk” of developing bone diseases such as osteoporosis or osteomalacia. The beverage in an alternate formulation further supplies Vitamin E and Carotenoids such as xeazanthin, lycopene and lutein to improve cardiovascular health and eyesight in the elderly. The beverage in addition provides the antioxidant benefits of anthrocyanins and improves cognitive performance after strenuous exercise.

Another persistent problem with respect to milk-based beverages is the presence of bacteria such as coliform, an enteric variety. Pasteurization has been, until now, the standard method used to eliminate, or at least minimize the development of bacterial colonies so as to extend the useable shelf life of milk or milk-based products. Pasteurization, in its simplest form, involves the application of heat to a substance for a specified time to destroy potentially harmful microorganisms. Variations on the standard pasteurization method have been developed to further extend the shelf life of products such as milk. One such variation is known as HTST (high temperature short time) pasteurization that utilizes temperatures of from about 165° F. to about 195° F. and time periods from about 2 seconds to about 30 seconds. Exposure time is inversely proportional to the temperature used.

A second variation is VAT pasteurization that utilizes temperatures up to about 175° F. for a time period up to about 40 minutes. A yet further variation, UHT (ultra-high temperature) pasteurization, utilizes temperatures in excess of 215° F. for about 2 to about 5 seconds. UHT pasteurization is often used to extend the shelf life of chocolate flavored milk drinks from 14 days under refrigeration with standard heat pasteurization to up to 90 days under refrigeration, and is the method typically used when chocolate milk drinks are to be kept refrigerated on store shelves for over 21 days. Whether standard or UHT pasteurization is used, stabilizers and preservatives have to be added to provide a stable product. If vitamins and minerals are added to flavored milk drinks that are to be pasteurized, gel binders are also added to stabilize the flavors, colors and nutritive additions. Gel binders present additional problems. It is well known that various gel binders have a significant negative laxative effect on susceptible individuals, e.g., children and the elderly. This is a yet further reason why certain individuals forego drinking even flavored milks.

Problems with off flavors and poor mouth feel may persist when standard methods of UHT pasteurization are used, even with the use of stabilizers and preservatives. It is known that exposing milk or milk-based products to high heat may degrade certain components such as Riboflavin and Vitamin A, destroys Vitamin C, and breaks down lactose, a disaccharide sugar into its monosaccharide components. The latter effect generates off flavors. What is needed is an alternative to traditional methods of Pasteurization that extends the useful shelf life of milk-based products without causing any degradation in the product, and without needing binders, stabilizers or preservatives.

We have discovered that by exposing milk-based beverages to CO₂ pre-pasteurization, the growth of bacteria colonies can be suppressed, and degradation of flavors and nutrients can be reduced and the need for gel binders or stabilizers can be eliminated. In fact, depending on the amounts of CO₂ added, the need for traditional pasteurization can also be eliminated without any appreciable negative impact on the suppression of bacteria. We have further discovered that by separating the milk into its two physical components (solid phase and liquid phase), each phase may be treated differently to achieve the maximum sterility with the least use of high heat energy to preserve flavor and liable components.

### SUMMARY OF THE DISCLOSURE

The beverage disclosed herein serves as a means of enhancing the attractiveness of milk based beverages in the marketplace as well as providing a delicious source of essential nutritional elements in the daily diet needed to improve the daily diet of children, reduce obesity, reduce the incidence of cardiovascular disease and high blood pressure in adults, promote the formation of healthy bones and teeth, reduce the incidence of osteoporosis and increase physical vigor, strength and endurance and improve cognitive function after strenuous exercise. The beverage also supplies more rapidly absorbed and higher levels of calcium, magnesium and potassium without gastric upset and stomach bloating. This disclosure further provides a pleasant vehicle for the consumption of the recommended daily requirements of essential nutrients by youth who are “AT RISK” of developing rickets, osteomalacia and other bone diseases.

The beverage described herein has carbonation to enhance taste, improve body and mouth-feel, increase acceptability of dairy beverages and aid in the stabilization of milk protein such as Lactalbumin and Casein. In one embodiment, the activity of milk lactose is neutralized by filtration of the milk through a spiral membrane filter packed with Saccharomyces cerevisiae yeast cells to reduce the possibility of allergic response such as lactose intolerance in susceptible individuals. Optionally, pure crystalline fruit fructose, high fructose corn syrup, cane sugar, a natural high intensity sweetener from the group Stevia, Sucralose, Acesulfame K, Aspertain, Fruit Syrups from Plum, Grape, Pear, Apple, Berry, Siraitia grosvenori Fruit, Sweet Proteins such as Brazzein, Thaumatin, Monellin, Curculin, Mabinlin, Miraculin, Pentadin, or combinations thereof, can be added to enhance taste, flavor and health or therapeutic value of the beverage.

Flavors such as chocolate fudge, chocolate, vanilla, mocha, almond, coconut, latte, butterscotch, coffee and fruit flavors such as peach, orange, raspberry, strawberry, saskatoon berry, blueberry, plains berry, prairie berry and apple as well as mixtures thereof can be added to enhance taste and acceptability.

Also disclosed is a method of making the beverage that employs, in one embodiment, the addition of CO₂ pre-Pasteurization to eliminate or effectively reduce the growth of bacterial colonies in the beverage and reduce degradation of nutrients. In another embodiment, a variety of gases are used to de-aerate the beverage to enhance the stability of the underlying mixture. In a further embodiment, a mixture of liquid or gas nitrogen and carbon dioxide are added post pasteurization to enhance beverage stability and shelf life and to reduce the amount of carbon dioxide needed to prevent bacterial and/or mold growth among other benefits. These and other advantages will become apparent from a reading of the following detailed description. In an additional embodiment, the milk ingredient is separated into its two physical phases (solid and liquid) and purified individually before quantitative recombination to provide the maximum safety against harmful contamination and to stabilize labile components by the use of lower heat in the preparation of the beverage.

### DETAILED DESCRIPTION OF THE DISCLOSURE

The beverage composition in its broadest aspect comprises nonfat dry milk, milk (whole or 1%, 2% fat), skim milk, milk whey, milk protein concentrate, soy milk, yogurt or a non-dairy milk substitute containing sweet dairy whey, dried corn syrup, sodium caseinate and partially hydrogenated soybean oil. Alternatively, the composition can be comprised of nonfat dry milk, skim milk, milk (whole or 1%, 2% fat), milk whey, milk protein concentrate, soy milk or yogurt and can be combined with a mixture of nonfat dry milk, skim milk, milk (whole or 1%, 2% fat), milk whey, milk protein concentrate, soy milk or yogurt and/or the milk substitute.

More particularly, the beverage composition comprises a beverage solution containing in each 354 ml: from about 0.01 g to about 1000 g of nonfat dry milk and/or from about 1 ml to about 350 ml of skim milk and/or from about 1 ml to about 350 ml milk (whole or 1%, 2% fat), and/or from about 1 gm to about 500 g milk whey, and/or from about 1 mg to about 800 mg milk protein concentrate, and/or from about 1 ml to about 350 ml soy milk, and/or from about 1 mg to about 200 g yogurt, and/or from about 1 g to about 500 g of a nonfat milk substitute containing sweet dairy whey, dried corn syrup, sodium caseinate, partially hydrogenated soybean oil and/or mixtures thereof.

The beverage compositions also may broadly comprise Amelanchia Alnifolia Purified Liquid Extract per 354 ml of beverage solution of from about 1 ml to about 344 ml of solution. The beverage compositions further comprise a beverage solution containing per 354 ml: from about 1 mg to about 7600 mg of calcium picolinate, and/or from about 1 mg to about 7600 mg of calcium aspartate, and/or from about 1 mg to about 9,000 mg of calcium gluconate, and/or from about 1 mg to about 9,000 mg of calcium ascorbate, and/or from about 1 mg to about 9,000 mg of calcium lactate and/or mixtures thereof.

The calcium picolinate, calcium aspartate, calcium gluconate, calcium ascorbate and/or calcium lactate in these quantities provide a more easily assimilatable source of from about 0.01 meq to about 119 meq of calcium ions. Preferably, from about 0.01 meq to about 71 meq of calcium ions (or from about 2.1 mg to about 1400 mg of calcium ions) is provided to the human body with each 354 ml of beverage solution.

The calcium ions are bivalent cations, which combine with the picolinate, aspartate, gluconate, ascorbate and lactate ligands through coordination. The coordinating picolinate, aspartate, gluconate, ascorbate or lactate ligands are attached to the bivalent cations (electron acceptors) by means of a lone pair of electrons.

After ingestion, the bivalent cations (calcium ions) remain bonded to the picolinate, aspartate, gluconate, ascorbate or lactate ligands and are selectively absorbed through the intestinal membrane of humans. Thus, the beverage compositions comprise beverage solutions containing per 354 ml: from about 0.01 meq to about 71 meq of calcium ions supplied by from about 1 mg to about 7600 mg of calcium picolinate and/or calcium aspartate where the 0.01-71 meq of calcium ions are bonded to the picolinate, aspartate, gluconate, ascorbate or lactate donor agent within the beverage solution and are included within the compounds calcium picolinate, calcium aspartate, calcium gluconate, calcium ascorbate and/or calcium lactate.

The beverage composition also broadly comprises calcium phytate and/or a calcium compound selected from the group consisting of calcium acetate, calcium caseinate, calcium glutamate, calcium pyruvate, calcium palmitate and mixtures thereof. More specifically, the beverage compositions comprise a beverage solution containing per 354 ml: from about 0.01 mg to about 1700 mg of calcium phytate, and/or from about 0.01 mg to about 1700 mg of calcium acetate, and/or from about 0.01 mg to about 1700 mg of calcium caseinate and/or from about 0.03 mg to about 3700 mg of a mixture of calcium phytate, calcium acetate and/or calcium caseinate.

Should the calcium compound include calcium glutamate, calcium phytate and/or calcium palmitate, the beverage compositions would comprise a beverage solution containing per 354 mg: from about 0.01 mg to about 1700 mg of calcium glutamate, from about 0.01 mg to about 7000 mg of calcium palmitate and/or from about 0.01 mg to about 9500 mg of a mixture of calcium glutamate, calcium phytate and calcium palmitate.

Alternatively, the beverage compositions of this disclosure comprise a beverage solution containing per 354 ml: from about 1 mg to about 9400 mg of a calcium compound selected from the group consisting of calcium acetate, calcium caseinate and mixtures thereof. The calcium phytate, calcium acetate, calcium caseinate, calcium glutamate, calcium pyruvate and/or calcium palmitate (or any of the calcium compounds including calcium acetate, calcium aspartate, calcium ascorbate, calcium gluconate, calcium picolinate, calcium lactate) in these quantities provide from about 0.01 meq to about 71 meq of calcium ions (or from about 2.1 mg to about 1400 mg of calcium ions) to the human body per 354 ml of beverage solution.

The calcium ions combine with the bidentate ligands (picolinate, aspartate, gluconate and pyruvate) by coordinate bonding and remain bonded to the ligands until after transport through the intestinal barrier by selective absorption. Calcium ions, which are not bonded to bidentate ligands generally, are not absorbed through the amino acid selective loci of the human intestinal membrane. To enhance the addition of calcium to the beverage composition, tri-calcium phosphate can be added. From about 10 mg to about 7000 mg of tri-calcium phosphate may be added at ambient to 90° F. with agitation to assure solubalization of the mineral compound.

The beverage composition further broadly comprises the above described calcium compounds and a magnesium compound selected from the group consisting of magnesium picolinate, magnesium aspartate, magnesium gluconate, magnesium ascorbate, magnesium lactate, magnesium phytate, magnesium acetate, magnesium caseinate, magnesium glutamate, magnesium pyruvate, magnesium palmitate and/or mixtures thereof.

More particularly, the beverage composition comprises a beverage solution containing per 354 ml: from about 0.01 mg to about 10,000 mg of magnesium picolinate and/or from about 1 mg to about 9400 mg of a magnesium compound selected from the group consisting of magnesium aspartate, magnesium gluconate, magnesium ascorbate, magnesium lactate, magnesium phytate, magnesium acetate, magnesium caseinate, magnesium glutamate, magnesium pyruvate, magnesium palmitate and mixtures thereof and/or from about 2 mg to about 3900 mg of magnesium aspartate, magnesium gluconate, magnesium acetate, magnesium pyruvate, magnesium palmitate, magnesium ascorbate, and/or magnesium lactate and/or from about 0.01 mg to about 10,000 mg of magnesium phytate and/or magnesium caseinate and/or from about 2 mg to about 4000 mg of magnesium glutamate and/or from about 1 mg to about 9700 mg of a magnesium compound selected from the group consisting of magnesium aspartate, magnesium gluconate, magnesium ascorbate, magnesium lactate, magnesium phytate, magnesium acetate, magnesium caseinate, magnesium glutamate, magnesium pyruvate, magnesium palmitate and mixtures thereof. To enhance the addition of magnesium to the beverage composition, di-magnesium trihydrate can be added from about 0.01 mg to about 100 mg.

The described calcium compounds and magnesium compounds in these indicated quantities provide from about 0.01 meq to about 71 meq of calcium ions and from about 0.01 meq to about 60 meq of magnesium ions to the human body with each 354 ml of beverage solution. The magnesium ions are bivalent cations that combine with the picolinate, aspartate, gluconate, ascorbate or lactate ligands though coordination. The coordinating ligands are attached to the bivalent cations by means of a lone pair of electrons. After ingestion, these bivalent cations (magnesium ions) remain bonded to the ligand and are selectively absorbed through the intestinal membrane of humans.

The magnesium ions released or disassociated from the magnesium compounds help to facilitate the selective absorption of the calcium compounds through the intestinal loci and into the blood stream of humans. In one embodiment of the beverage composition, the beverage solution contains per 354 ml: from about 0.01 meq to about 71 meq of calcium ions and from about 0.01 meq to about 60 meq of magnesium ions supplied by from about 2 mg to about 9700 mg of a magnesium compound selected from the group consisting of magnesium picolinate, magnesium aspartate, magnesium gluconate, magnesium ascorbate, magnesium lactate, magnesium phytate, magnesium acetate, magnesium caseinate, magnesium glutamate, magnesium pyruvate, magnesium palmitate and mixtures thereof.

The embodiment can additionally comprise from about 0.01 meq to about 50 meq of potassium ions supplied by from about 0.01 mg to about 11,000 mg of potassium picolinate, and/or from about 10 mg to about 1200 mg of potassium aspartate, and/or from about 10 mg to about 3500 mg of potassium gluconate, and/or from about 10 mg to about 2500 mg of potassium ascorbate, and/or from about 19 mg to about 2300 mg of potassium lactate, and/or from about 0.01 mg to about 5000 mg of potassium phytate, and/or from about 10 mg to about 2600 mg of potassium acetate, and/or from about 10 mg to about 2700 mg of magnesium glutamate, and/or from about 2 mg to about 4000 mg of potassium pyruvate, and/or from about 0.01 mg to about 3700 mg of potassium palmitate, and/or from about 10 mg to about 3100 mg of a mixture of a potassium compound selected from the group consisting of potassium picolinate, potassium aspartate, potassium gluconate, potassium ascorbate, potassium lactate, potassium phytate, potassium acetate, potassium caseinate, potassium glutamate, potassium pyruvate, potassium palmitate and mixtures thereof.

The potassium ion tends to form weak bonds due to the presence of a single valence electron. However, the potassium ion can be complexed with an amino acid and therefore remain complexed to picolinate, aspartate, gluconate, pyruvate or glutamate until after passage through the intestinal walls of humans. Whenever the beverage composition is comprised of from about 0.01 meq to about 50 meq of potassium ascorbate, potassium lactate, potassium phytate, potassium acetate or potassium caseinate, the potassium compound will dissociate with the potassium ion and be free to complex with an excess of any picolinate, aspartate, gluconate, pyruvate or glutamate present. To enhance the addition of potassium to the beverage composition, di-potassium phosphate can be added from about 0.01 mg to about 100 mg.

The disclosure also comprises a sweetener agent selected from the group consisting of sucrose, high fructose corn syrup, invert sugars, crystalline fructose, fructose polymers, aspartame, glucose, glucose polymers, sucralose, Saccharine, Stevia, Fruit concentrates, Sweet proteins, Siraitia grosvenori Fruit and mixtures thereof. Preferably, the sweetener agent is selected from the group consisting of sucrose, crystalline fructose, fructose polymers, glucose, glucose polymers, Aspartame, sucralose, acesulfame K, fructose syrup, glucose syrup, corn syrup, invert sugar, sugar alcohols, maple syrup, honey, fruit syrups (apple, grape, and pear), Stevia, Sweet proteins, Siraitia grosvenori Fruit and/or mixtures thereof. The sweetener agent for the non-dietetic formulation may be crystalline fructose, fructose syrup, corn syrup or fruit syrups, and for the dietetic formulation may be sucralose or Aspartame, acesulfame K, Stevia, Sweet Proteins, Siraitia grosvenori Fruit and/or mixtures thereof.

Crystalline fructose is the preferred sweetener agent for the disclosure in the non-dietetic form. Fructose is absorbed by humans through a facilitated diffusion process. Its movement across the intestinal membrane is more rapid than would be expected from simple diffusion. Facilitated diffusion involves the intermediary formation of a complex with a specific transport or carrier protein. If crystalline fructose is used as the sweetening agent, from about 0.01 g to about 50 g is used per 354 ml of beverage solution. If fructose polymers are used as a sweetening agent for this disclosure, from about 0.1 g to about 1000 g is used per 354 ml of beverage solution. Fructose polymers, as is known in the art, impart enhanced nutritional activity due to the way the substance is transported through the intestinal tract and processed by the body.

If sucrose is used as the sweetener, from about 0.01 g to about 100 g is used per 354 ml of beverage solution. If Aspartame is used as the sweetener, from about 0.05 g to about 30 g is used per 354 ml of beverage solution. If sucralose is used as the sweetener, from about 0.01 g to about 30 g is used per 354 ml of beverage solution. If acesulfame K is used as the sweetener, from about 0.01 g to about 20 g is used per 354 ml of beverage solution. If glucose polymers are used as the sweetener, from about 0.01 g to about 1000 g is used per 354 ml of beverage solution. If glucose is used as the sweetener, from about 0.01 g to about 100 g is used per 354 ml of beverage solution.

If Saccharine is used as the sweetener, from about 0.01 g to about 10 g is used per 354 ml of beverage solution. If fructose syrup is used as the sweetener, from about 0.5 g to about 100 g is used per 354 ml beverage solution. If glucose syrup is used as the sweetener, from about 0.3 ml to about 100 ml is used per 354 ml beverage solution. If corn syrup is used as the sweetener, from about 0.5 ml to about 100 ml is used per 354 ml beverage solution. If invert sugar is used as the sweetener, from about 0.5 g to about 100 g is used per 354 ml beverage solution. If sugar alcohols are used as the sweetener, from about 0.2 g to about 100 g is used per 354 ml beverage solution. If maple syrup is used as the sweetener, from about 0.1 g to about 100 g is used per 354 ml beverage solution. If honey is used as the sweetener, from about 1.0 g to about 100 g is used per 354 ml beverage solution. If fruit syrups (apple, grape, pear) are used as the sweetener, from about 1.0 g to about 100 g is used per 354 ml beverage solution.

If crystalline fructose, fructose polymers, fructose syrup, glucose, glucose syrup, corn syrup, invert sugar, sugar alcohols, maple syrup, honey, fruit syrups (apple, grape, pear), acesulfame K, glucose polymers, sucrose, Aspartame, Saccharine, sucralose and/or mixtures thereof are used as the sweetener, from about 0.01 g to about 200 g is used per 354 ml of beverage solution. If Stevia is used as the sweetening Agent, from about 0.001 mg to about 1000 mg is used per 354 ml beverage solution. If Sweet Proteins (i.e. Brazzein, Thaumatin, Monellin, Curculin, Mabinlin, Miraculin, and Pentadin) are used as the sweetener, from about 0.01 mcg to about 500 mg is used per 354 ml of beverage solution.

The beverage composition further can include a flavoring agent such as chocolate fudge, chocolate, vanilla, strawberry, prairie berry, mocha, latte, peach, almond, coconut, raspberry, saskatoon berry, plains berry, apple, orange, butterscotch, coffee, blueberry, bubble gum, cola, root beer, guarana and/or mixtures thereof. Flavors and/or mixtures thereof chosen from the list above will be added from about 0.01 g to about 50 g per 354 ml of beverage solution.

The beverage composition of all mixtures of this disclosure can also broadly comprise from about 50 IU (international units) to about 600 IU of vitamin D per 354 ml of beverage solution. The vitamin D is to be added in the above concentration to any mixture of the beverage solution.

Additionally, the beverage composition of all embodiments of the disclosure can comprise vitamin C (ascorbic acid). The vitamin C can be added from about 0.1 mg to about 1000 mg to any and all embodiments of the disclosure per 354 ml of beverage solution.

Further, the beverage composition of all embodiments of the disclosure will contain from about 3.50 mg to about 21.50 mg/354 ml of Anthrocyanins.

The beverage composition can also comprise folic acid. The folic acid can be added from about 0.001 mg to about 0.40 mg to all embodiments of the disclosure per 354 ml of beverage solution.

The beverage composition can also comprise vitamin A. The vitamin A can be added from about 200 IU to about 5000 IU to any and all embodiments of the disclosure per 354 ml of beverage solution.

Alternatively, or in addition, carotenoid can be added, which is a precursor of vitamin A. Zeaxanthin, lutein and lycopene are three carotenoids suitable for the beverage compositions herein described. If lutein is added as a carotenoid, then from about 0.0002 g to about 0.0009 g is added per 354 ml of beverage solution. If zeaxanthin is added as a carotenoid, then from about 0.0002 g to about 0.0009 g is added per 354 ml of beverage solution. If lycopene is added as a carotenoid, then from about 0.0002 g to about 0.0009 g is added per 354 ml of beverage solution.

It should be noted that there is no need to supplement the beverage compositions with the B complex vitamins, vitamin K, and phosphorous in the skim milk, nonfat dry milk powder, milk (whole or 1%, 2% fat) and yogurt. Adequate dietary quantities of these vitamins and minerals are present in the dairy elements.

A yet further optional nutritive additive is soy or more specifically, soy protein. Soy is known to contain phytoestrogens, which may have beneficial effects with respect to breast cancer. Amounts in excess of 10 micrograms added to the mixture are expected to produce the desired anti-cancer effect.

An additional optional nutritive additive is carotenoid, which is a precursor of vitamin A.

All mixtures of the beverage solution disclosed herein may also optionally comprise the addition of a preservative. The preservative used is preferably natural and bacteriostatic. The preferred preservative is Ascorbic Acid or benzoic acid and/or a benzoate compound such as sodium benzoate, potassium lactate, calcium benzoate and/or magnesium benzoate. When used in any and all embodiments of the Disclosure, these compounds comprise from about 0.15 g to about 0.70 g of ascorbic acid, benzoic acid, sodium benzoate, potassium benzoate, calcium benzoate, magnesium benzoate and/or mixtures thereof per 354 ml of beverage solution.

The beverage composition also comprises the addition of carbonation, i.e., the forceful introduction of carbon dioxide gas, under pressure, against a liquid surface, which causes the absorption of the gas into, and in the case of this disclosure, solubilization by the liquid. Preferably, from about 0.10 volumes to about 4 volumes of gas is added per 354 ml of beverage solution. The higher the gas pressure and the cooler the liquid, the more carbonation that is dissolved. Carbonation has the effect of enhancing the flavor, sweetness, taste, and mouth-feel and lowering the pH of the beverage as well as changing the viscosity to render it more desirable.

Another aspect of the disclosure is the method used to prepare the beverage composition. With any of the embodiments, a predetermined volume of a liquid solvent, Amelanchier alnifolia liquid extract is used. In general, from about 10 ml to about 344 ml of Amelanchier alnifolia liquid extract should be used for every 354 ml of beverage solution to be produced.

The Liquid Extract should be brought to and maintained at ambient temperature (70°-74° F.) to enhance solubility and prevent clumping of the solid ingredients to be added. After a selected amount of Liquid Extract is obtained, from about 1 g to about 1000 g of non-fat dry milk powder (prepared by low heat or freeze-dry methods as is known in the art) or from about 1 g to about 35 g of non-fat milk substitute powder containing sweet dairy whey, dried corn syrup, sodium caseinate and partially hydrogenated soybean oil or mixtures thereof is added.

In an alternate embodiment, about 350 ml of skim milk, milk (whole or 1%, 2% Fat), soy milk, liquid milk whey, yogurt and/or mixtures thereof can be used in place of the Liquid Extract solvent and one or both of the non-fat dry milk powder and the non-fat substitute powder. It is to be understood that the methods used to prepare the non-fat dry milk or the non-fat substitute powder (substances which are commercially available) are not part of the Disclosure. When the starting ingredient is fluid milk or milk whey, the addition of Liquid Extract is eliminated and the Anthrocyanins are added in powdered form from about 3.50 mg to about 1853 mg added per 354 ml.

In a preferred embodiment, from about 1.0 g to about 1000 g of non-fat dry milk is added to from about 150 ml to about 190 ml of Amelanchia alnifolia fluid extract prepared as follows:

1. Fruit Berries used are chosen from the class Amelanchia alnifolia, Elderberry, Blueberry, Raspberry, Bilberry, Acia, Golgi berries, or Pomegranate and their associated stems, skims and pomaces.
2. The fruit berries, stem, skins and pomaces are ground or crushed in a stainless steel jacketed tank.
3. Food grade CO₂ is bubbled with slow speed stirring into RO+water (Reverse Osmosis water) held in a jacketed tank at from about 35° to about 38° F.
4. The bubbling of CO₂ with stirring is continued until CO₂ content ranges reach from about 1 to about 4 volumes CO₂ in water.
5. The CO₂ mixture is then pumped at from about 35° to about 38° F. into the Crushed Fruit Berry Tank at a ratio of about 71 parts of CO₂/H₂O solution to about 1 part Berry skin, stem, pomace mixture with very slow (nonshear) agitation for about 1 hour while maintaining the tank at a temperature of from about 35° to about 38° F.
6. The berry/CO₂-water mixture is next passed through a continuous flow 0.2 micron filter to preserve the Permeate in a jacketed tank at from about 35° to about 38° F.

The mixture is next separated quantitatively into a solid phase (Retentate) and liquid phase (Permeate) by Ultrafiltration. The Permeate is next passed through a spiral nanofiltration membrane packed with Saccharomyces cerevisiae yeast cells to promote hydrolysis of the Milk Lactose. The filtered Permeate is captured in a jacketed tank and the temperature of the Permeate is maintained between from about 35° to about 38° F.

The solid phase (Retentate) is simultaneously treated with a mixture (from about 95 to about 5%) of beverage grade CO₂-Nitrogen at from about 35° to about 38° F. The two (2) gases stored in liquid form are passed through a warmer and blended on the way to the Retentate. During treatment, the Retentate is constantly rotated gently to assure complete exposure to the gas mixture and the temperature of the Retentate is maintained from about 35° to about 38° F. The CO₂-Nitrogen gas mixture is evacuated through a gas filter after about five (5) minutes of treatment and reclaimed for future use.

The Permeate is now pumped quantitatively with mixing into the tank containing the Retentate with stirring at low shear for at least ten minutes to assure complete colloidal solution. The temperature should be maintained at from about 35° to about 38° F. at all times. After complete colloidal solution, the temperature of the mixture is raised to about 60° F. by applying steam through the jacketed walls of the tank and a sugar or sugar substitute is added to the mixture. From about 0.01 g to about 50 g of crystalline fructose and/or from about 0.01 g to about 100 g of sucrose and/or from about 0.10 g to about 1000 g of fructose polymers and/or from about 0.05 g to about 30 g of Aspartame® and/or from about 0.01 g to about 30 g of sucralose and/or from about 0.01 g to about 100 g of glucose and/or from about 0.01 g to about 20 g of Saccharine® and/or from about 0.01 g to about 20 g of acesulfame K and/or from about 0.01 g to about 1000 g of glucose polymers and/or from about 0.5 g to about 100 g of fructose syrup and/or from about 0.5 g to about 100 g invert sugar and/or mixtures thereof are added to each 354 ml of the beverage mixture. The mixture is again stirred for a minimum of about ten (10) minutes.

The Milk or Reconstituted Milk Powder prepared with Amelanchia alnifolia Liquid Extract as disclosed above is next separated quantitatively into its two (2) physical phases (solid and liquid) by Ultrafiltration, UltraCentrifugation, Bactofugation or other acceptable means. The liquid phase (Permeate) is next passed through a Spiral nanofiltration column packed with Saccharomyces cerevisiae (Yeast) cells to promote hydrolysis of the Milk Lactose. The filtered Permeate is captured in a jacketed tank and the temperature of the Permeate is maintained at from about 35° to about 38° F. The solid phase (Retentate) is simultaneously treated with a mixture (about 95% to about 5%) of beverage grade CO₂ and Nitrogen. The two (2) gases stored in liquid form are passed through a warmer (to bring the gases up to about 40° F. to convert them back to gaseous forms) and blended on the way to the Retentate treatment.

During treatment, the Retentate is rotated gently to assure complete exposure to the gas mixture and the temperature of the Retentate is maintained at from about 35° to about 38° F. After treatment, the gas mixture is evacuated through a gas filter and reclaimed. The Permeate is now pumped quantitatively with mixing into the tank containing the Retentate while maintaining the temperature of the mixture at from about 35° to about 38° F. The milk solution is now mixed at low shear for a minimum of about ten (10) minutes. After thorough mixing, the temperature of the milk solution is now raised up to about 60° F. with stirring by applying steam through the walls of the jacketed tank.

After the temperature is reached, the following ingredients are added to the tank with stirring: from about 1.0 mg to about 7600 mg of a calcium salt selected from the group consisting of calcium picolinate, calcium aspartate and mixtures thereof, or from about 1.0 mg to about 9000 mg of a calcium salt selected from the group consisting of calcium gluconate, calcium lactate, calcium ascorbate and mixtures thereof, or from about 0.01 mg to about 1700 mg of a calcium salt selected from the group consisting of calcium phytate, calcium acetate, calcium caseinate, calcium glutamate, calcium palmitate and mixtures thereof, or from about 10 mg to about 9400 mg of calcium pyruvate or mixtures of any of the identified calcium salts are added to each 354 ml of the beverage mixture. The mixture is stirred for a second time for a minimum of about five minutes.

Following the second stirring step, from about 2.0 mg to about 3900 mg of a magnesium salt selected from the group consisting of magnesium aspartate, magnesium gluconate, magnesium ascorbate, magnesium lactate, magnesium acetate, or from about 0.01 mg to about 10000 mg of a magnesium salt selected from the group consisting of magnesium phytate, magnesium caseinate, magnesium pyruvate, magnesium palmitate, magnesium piconlinate and mixtures thereof, or from about 0.01 mg to about 10,000 mg of magnesium glutamate and mixtures of any of the identified magnesium salts are added to each 354 ml of the beverage mixture. The mixture is again stirred for a minimum of about five minutes.

Following the addition of the magnesium salt, a potassium salt is added to the mixture. From about 21 mg to about 11000 mg of potassium picolinate, and/or from about 10 mg to about 1200 mg of potassium aspartate, and/or from about 10 mg to about 3500 mg of potassium gluconate, and/or from about 21 mg to about 2500 mg of potassium ascorbate, and/or from about 19 mg to about 2300 mg of potassium lactate, and/or from about 10 mg to about 5000 mg of potassium phytate, and/or from about 10 mg to about 2600 mg of potassium acetate, and/or from about 10 mg to about 2700 mg of potassium glutamate, and/or from about 10 mg to about 4000 mg of potassium pyruvate, and/or from about 10 mg to about 3700 mg of potassium palmitate and/or mixtures thereof are added to each 354 ml of the beverage mixture. The mixture is again stirred for a minimum of about five minutes.

Optionally, from about 50 IU to about 600 IU of vitamin D is added to each 354 ml of the beverage mixture which is stirred for about an additional five minutes. Also optionally, from about 200 IU to about 2000 IU of vitamin A is added to each 354 ml of the beverage mixture, which is stirred for about another five minutes. Also optional is the addition of from about 0.001 mg to about 0.40 mg of folic acid to each 354 ml of the beverage mixture, which is stirred yet again for a minimum of about five minutes.

A sugar or sugar substitute is also added to the mixture. From about 0.01 g to about 50 g of crystalline fructose and/or from about 0.01 g to about 100 g of sucrose and/or from about 0.10 g to about 1000 g of fructose polymers and/or from about 0.05 g to about 30 g of Aspartame® and/or from about 0.01 g to about 30 g of sucralose and/or from about 0.01 g to about 100 g of glucose and/or from about 0.01 g to about 20 g of Saccharine@ and/or from about 0.01 g to about 20 g of acesulfame K and/or from about 0.01 g to about 1000 g of glucose polymers and/or from about 0.5 g to about 100 g fructose syrup and/or from about 0.5 g to about 100 g invert sugar and/or from about 0.001 mg to about 1000 mg Stevia and/or from about 0.01 mcg to about 500 mg Sweet Protein (Brazzein, Thaumatin, Monellin, Curcukin Mabinlin, or Pentadin) and/or mixtures thereof are added to each 354 ml of the beverage mixture. The mixture is again stirred for at least three minutes.

To enhance the taste of the mixture, from about 0.1 mg to about 50 mg of a flavoring agent selected from the group consisting of chocolate fudge, chocolate, vanilla, strawberry, prairie berry, mocha, latte, peach, almond, coconut, raspberry, saskatoon berry, plains berry, apple, orange, butterscotch, coffee, blueberry, cola, root beer and mixtures thereof is added. The mixture is again stirred for a minimum of about two minutes.

Optionally, an acidulant can be added, to adjust the pH of the mixture. Acidulants useful with the disclosure include, but are not limited to, tartaric acid, ascorbic acid, malic acid, lactic acid, citric acid and fumaric acid. Tartaric, malic and fumaric acids are particularly advantageous in that these acidulants appear to enhance the absorption of minerals such as calcium, magnesium and potassium. Phosphoric acid is not used because it prevents the absorption of calcium. If an acidulant is used, it is important that the pH be monitored to prevent the composition's pH from dropping below the isoelectric point of milk protein, which is 4.7 pH. When using tartaric, malic, fumaric, lactic, ascorbic and citric acids as acidulants, use from about 0.01 g to about 10 g per 354 ml beverage solution.

The carotenoids, if used, as well as the di-potassium phosphate, di-magnesium phosphate and tri-calcium phosphate are added in the beginning after heating the water, milks or milk whey. They are then added with stirring until dissolved.

After the addition of all ingredients, the beverage mixture is mixed at low shear for a minimum of about ten (10) minutes. This is in addition to the other steps that involve mixing.

Another issue that arises when mixing and blending the ingredients is the undesirable introduction of aeration into the mixture. Oxygen is trapped in the mixture during blending, which can destabilize the product if allowed to remain resident in the mixture. To eliminate the presence of unwanted oxygen, a gas is used to de-aerate the mixture. Suitable gases include carbon dioxide, nitrogen, or any inert gas such as argon. Each will eliminate the presence of oxygen; carbon dioxide, however, is the only de-aeration gas that will be solubilized in the mixture and advantageously provides a dual function as it will also be used for the carbonation of the beverage.

Pre-pasteurization, the carbon dioxide is bubbled into the bottom of the mixing tank after mixing all ingredients. For purposes of adding carbonation, carbon dioxide gas is added to the milk mixture, in line, just after pasteurization. The temperature of the fluid mixture, in line, should be brought down to below about 40° F. and the carbon dioxide gas flow is controlled with a regulator to from about 500 ppm to about 3000 ppm.

Following the addition of all essential and optional ingredients, the mixture is pasteurized at from about 165° to about 178° F. for about 20 seconds in an HTST pasteurizer or from about 165° to about 170° F. for about 30 minutes in a VAT pasteurizer. UHT pasteurization may be used, but is not recommended due to the possibility of sugar carmelization. After pasteurization, the mixture is cooled down to from about 32° to about 35° F. and then transferred through a CO₂ Sparger set at a flow rate of about 1.5 volumes/minute to a jacketed Stainless Steel holding tank with mixing while maintaining the temperature of the batch from about 34° to about 38° F. until the complete batch is accumulated in the tank. The CO₂ level of the beverage is checked with a sample drawn from the tank using a Mocon device or some other FDA approved method. The mixture is maintained within a pH range of from about 4.7 to about 7.0. Carbon dioxide gas may be used as the pH adjusting agent. From about 0.1 volumes to about 4.0 volumes per 354 ml of beverage solution is used to maintain the solution within the desired pH range. The higher the CO₂ content, the lower the pH.

Pressurized carbon dioxide (CO₂) gas is forced through the beverage mixture from about 0.1 volumes to about 4.0 volumes per 354 ml of beverage mixture. The mixture is then dispensed into coated aluminum or steel beverage cans and/or PET containers and/or glass containers and/or aluminum foil lined EVOH (ethylene vinyl alcohol) containers and sealed to retain carbonation using closure methods well known in the art. In a yet further embodiment, the beverage may be filled in a flexible package produced as a multiple laminate of polyethylene foil, 0.3-1.0 microns, and Mylar which is both a barrier on the inner surface to oxygen, carbon dioxide and nitrogen. The material is also printable on the outer surface. To maintain the taste quality of the beverage, the beverage must be stored at temperatures in the range of from about 34° F. to about 72° F.

In an alternate embodiment, a dry beverage mixture embodiment, the beverage mixture is prepared as described above with the following exceptions: 1) the Liquid Amelanchia alnifolia extract is not added; 2) all the solid essential and desired optional ingredients are combined and blended in a ribbon or dry blender; 3) the carbon dioxide gas is not added to the preparation; and 4) the dry mixture is packaged in polyethylene-foil-polyethylene laminate pouches for later use. This allows the pre-beverage mixture of solids to be stored for long periods of time without having to take precautions to prevent carbonation depletion such as maintaining the mixture at a selected temperature range. When the liquid beverage is desired, Liquid Amelanchia alnifolia and carbonation are added to the mixture using the methods described above to produce a completed beverage mixture that is ready for consumption.

To inhibit the growth of bacterial colonies in the various beverage embodiments, the beverage can be pasteurized prior to the addition of the CO₂. HTST pasteurization may be the method used. However, other methods known well in the art can also be used with the addition of CO₂ gas to achieve the same bacteria suppression, but not cause degradation of nutrients, e.g., VAT, UHT or aseptic pasteurization. If HTST pasteurization is used, the beverage, pre-carbonation, is subjected to about 165° F. heat for about 30 seconds, and about 178° F. heat for about 20 seconds. If VAT pasteurization is used, the beverage, pre-carbonation, is subjected to a temperature of about 170° F. for about 30 minutes. If UHT or aseptic pasteurization is used, the beverage, pre-carbonation, is pasteurized at a temperature of about 215° F. for about 5 seconds.

In an alternate embodiment, CO₂ is bubbled into the beverage pre-pasteurization step, in an amount ranging from about 500 to about 10,000 parts per million (ppm) at ambient temperature for up to about 5 minutes. By employing this procedure, the total colony count of bacteria normally present in a milk-based medium was decreased six-fold. It was found that the higher the CO₂ amount and the longer the product was exposed to CO₂, the lower the bacterial count. Another added benefit is the demonstrable increase in the solubility of Calcium, Magnesium and Potassium salts and flavoring agents. A yet further benefit of pre-Pasteurization CO₂ introduction is the ability to use lower amounts of flavorings and sweeteners due to the sensory enhancement effects of the CO₂. A still further advantage is the elimination of the need for homogenization, which reduces the production costs and eliminates possible deleterious effects on ingredient solubility and the undesirable effects of introducing the mixture to high temperatures during the homogenization process.

Optionally, the beverage can then be pasteurized using any of the known pasteurization methods. If pasteurization is used, CO₂ has to be reintroduced into the beverage since pasteurization disseminates most CO₂ present. First, the beverage's temperature has to be brought down to from about between 165° F. and 215° F. to below 35° F. after pasteurization. The beverage mixture may be transported through chilled stainless steel or glass pipes for a minimum distance of about 50 feet with back pressure to assure thorough mixing. CO₂ is bubbled into the beverage mixture at a rate of from about 500 ppm to about 3000 ppm. The combination of milk protein, low temperature and length of the flow tube used to introduce CO₂ into the beverage mixture maximizes the CO₂ concentration to from about 500 ppm to about 3000 ppm in the finished product. 500 ppm is about 0.25 volumes. CO₂ concentrations are expressed herein in either ppm or volume units. To convert from one unit to the other, 1000 ppm is equivalent to about 0.5 volumes. If heat pasteurization is to be omitted, the CO₂ added at the pre-pasturization step must be added in a closed vessel with the internal temperature reduced to below about 38° F. to support solution.

Beverages made with the CO₂-Pasteurization-CO₂ combination exhibited bacterial counts of less than 60 colonies per field. No coliform colonies were found. The effective shelf life of the disclosed milk-based beverages was increased by 70 days to over 80 days with refrigeration. It is fully expected that similar results should be realized with increased pressure and even without the pasteurization step, based on the test results taken after the initial CO₂ infusion, described above. It is thus possible to prepare milk-based beverages without pasteurization and achieve acceptable bacteria levels. Elimination of the pasteurization step should also reduce production costs as carbonating a beverage under pressure is much less expensive than pasteurizing the same beverage, particularly with respect to equipment and energy needs.

In a further embodiment, from about 0.1 to about 4 volumes of Nitrogen is mixed with from about 0.1 to about 4 volumes of CO₂ per 354 ml of beverage solution. The addition of Nitrogen with the carbon dioxide exhibits several advantages. The nitrogen/carbon dioxide mixture provides additional protection from oxygen pick-up by the beverage. The mixture also reduces the amount of carbon dioxide needed to prevent bacterial and/or mold growth, which extends shelf life. The nitrogen component has a low solubility, less than 2%, which means it will leave the beverage when the container is opened. The carbon dioxide component has a higher solubility and remains in the beverage to provide the desired sensory benefits. Another added benefit is that the presence of nitrogen reduces the amount of carbon dioxide needed, which, in turn, lowers the acidity without affecting the extended shelf life. Additional benefits include improvement in texture, taste and appearance of the beverage as well as ice-crystal growth inhibition in low temperature beverage storage and a reduction of the incidences of GERD (Gastric Esophageal Regurgitation Disease) in susceptible individuals.

There are at least two ways in which the Nitrogen may be introduced into the beverage. The first is to introduce the Nitrogen in liquid form. The second is by gas sparger. Whichever option is chosen, each is added after any Pasteurization step.

It is to be understood that the sequence of adding the ingredients as set forth herein is not essential to the production of the beverage mixture with one exception. It is important that the calcium salt(s) be added to the mixture before the magnesium salt(s) to prevent undesired clumping.

Having described the disclosure, it should be understood that the foregoing description is intended merely to be illustrative thereof and that other modifications, embodiments and equivalents may be apparent to those skilled in the art without departing from its spirit. Having thus described the disclosure, what we claim as new and desire to secure by United States letters patent is:

1. A beverage composition suitable for human consumption comprising per 354 ml of composition:
from about 10 ml to about 344 ml of Amelanchia alnifolia Liquid Extract;
from about 1 g to about 35 g of a non-fat milk substitute comprising sweet dairy whey, dried corn syrup, sodium caseinate and partially hydrogenated soybean oil;
from about 0.01 meq to about 119 meq of calcium ions supplied from about 1 mg to about 9,000 mg of a calcium salt selected from the group consisting of calcium picolinate, calcium aspartate, calcium gluconate, calcium ascorbate, calcium benzoate, tricalcium phosphate and/or mixtures thereof;
from about 0.01 g to about 1000 g of a sweetener; and
from about 0.1 volumes to about 4 volumes of carbon dioxide gas.

2. The beverage composition of claim 1 wherein the sweetener is crystalline fructose, acesulfame K, aspartame, sucralose, fructose polymers, glucose, glucose polymers, glucose syrup, fructose syrup, corn syrup, invert sugar, saccharine, sucrose, crystalline fructose, sugar alcohols, honey, maple sugar, fruit syrups (apple, grape, pear), Stevia, Sweet Protein (Brazzein, Thaumatin, Monelin, Curculin, Mabinlin, Miraculin, Pentadin), Siraitia grosvenori Fruit and/or mixtures thereof.

3. The beverage composition of claim 2 further comprising from about 0.01 g to about 50 g of a flavoring agent.

4. The beverage composition of claim 3 wherein the flavoring agent is selected from the group consisting of chocolate fudge, chocolate, vanilla, vanilla cappuccino, guarana, strawberry, prairie berry, mocha, latte, peach, almond, coconut, raspberry, bubblegum, cotton candy, papaya, saskatoon berry, plains berry, apple, orange, butterscotch, coffee, blueberry, orange, cherry, tea, banana, lemon, lime, grape, watermelon, cola, root beer and/or mixtures thereof.

5. The beverage composition of claim 1 further comprising from about 50 IU to about 600 IU of vitamin D.

6. The beverage composition of claim 1 further comprising from about 0.1 mg to about 1000 mg of vitamin C.

7. The beverage composition of claim 1 further comprising from about 200 IU to about 5000 IU of vitamin A.

8. The beverage composition of claim 1 further comprising from about 0.001 mg to about 0.40 mg of folic acid.

9. The beverage composition of claim 1 further comprising from about 50 IU to about 600 IU of vitamin D; from about 0.1 mg to about 1000 mg of vitamin C; from about 200 IU to about 5000 IU of vitamin A and from about 0.001 mg to about 0.4 mg of folic acid and/or 50 IU to 500 IU vitamin E and/or 0.0002 g to 0.0009 g lutein and/or 0.0002 g to 0.0009 g zeaxanthin and/or mixtures thereof.

10. The beverage composition of claim 1 further comprising from about 0.15 g to about 0.70 g of a preservative.

11. The beverage composition of claim 10 wherein the preservative is Ascorbic Acid, benzoic acid or a benzoate compound selected from the group consisting of sodium benzoate, potassium benzoate, calcium benzoate, magnesium benzoate, citric acid, lactic acid and/or mixtures thereof.

12. The beverage composition of claim 1 wherein the composition has a pH of from about 4.7 to about 7.0.

13. The beverage composition of claim 1 further comprising the filtration of the Milk through a Spiral nanofilter containing Saccharomyces cerevisiae (Yeast) cells to eliminate the allergic activity of Milk Lactose.

14. The beverage compositions of claim 1 further comprising from about 0.01 meq to about 60 meq of magnesium ions supplied from about 0.1 mg to about 10,000 mg of a magnesium salt selected from the group consisting of magnesium picolinate, magnesium aspartate, magnesium gluconate, magnesium ascorbate, magnesium benzoate, magnesium phytate, magnesium acetate, magnesium caseinate, magnesium glutamate, magnesium pyruvate, magnesium palmitate, dimagnesium phosphate and/or mixtures thereof.

15. The beverage composition of claim 1 further comprising from about 0.01 meq to about 50 meq of potassium ions supplied from about 0.01 mg to about 11,000 mg of a potassium salt selected from the group consisting of potassium picolinate, potassium aspartate, potassium gluconate, potassium ascorbate, potassium benzoate, potassium phytate, potassium acetate, potassium glutamate, potassium pyruvate, potassium palmitate, potassium caseinate, dipotassium phosphate, potassium trihydrate and/or mixtures thereof.

16. (canceled)

17. The beverage composition of claim 1 further comprising adding carbon dioxide to beverages containing milk to improve mouthfeel and acceptance of the product by populations who do not drink or like milk.

18. The beverage of claim 1 further comprising CO₂ gas added prior to HTST pasteurization to reduce degradation of essential nutrients and extend shelf life by suppressing bacterial growth.

19. (canceled)

20. (canceled)
